(19) United States
(12) Patent Application Publication
(10) Pub. No.: US 2013/0201607 A1
(43) Pub. Date: Aug. 8, 2013

(54) PRESSURISED GAS-INSULATED MULTI-PHASE CONTROL PANEL

(71) Applicants: Manfred Meinherz, Berlin (DE); Sascha Meinherz, Hohen Neuendorf (DE)

(72) Inventors: Manfred Meinherz, Berlin (DE); Sascha Meinherz, Hohen Neuendorf (DE)

(73) Assignee: SIEMENS AKTIENGESELLSCHAFT, Muenchen (DE)

(21) Appl. No.: 13/807,760

(22) PCT Filed: Jun. 9, 2011
(86) PCT No.: PCT/EP2011/059617

§ 371 Date: Feb. 6, 2013

(30) Foreign Application Priority Data
Jun. 29, 2010 (DE) 10 2010 026 014.2

(51) Int. Cl. H02B 13/035

(52) U.S. Cl. CPC H02B 13/035
USPC 361/618

(57) ABSTRACT

A compressed-gas-insulated polyphase switch panel includes a circuit-breaker module. The circuit-breaker module is equipped with a first connection side and a second connection side. The first connection side is connected to a busbar module. The second connection side is connected to a bushing module. The bushing module and the busbar module have polyphase compressed-gas-insulated phase conductor sections. The circuit-breaker module is respectively connected through connection modules to the busbar module and to the bushing module. Each of the connection modules includes single-phase compressed-gas-insulated phase conductor sections. The circuit-breaker module likewise has single-phase compressed-gas-insulated phase conductor sections.

The invention relates to a compressed-gas-insulated polyphase switch panel having a circuit-breaker module with a first connecting side, which is connected to a busbar module, and with a second connecting side, which is connected to a bushing module, with the circuit-breaker module having single-phase-compressed-gas-insulated phase conductor sections, and with the busbar module having polyphase-compressed-gas-insulated phase conductor sections.

By way of example, a switch panel such as this is known from patent specification DE 198 07 777 C1. The switch panel there is in the form of a polyphase switch panel, with compressed-gas insulation being used in order to electrically insulate the phase conductor sections. A circuit-breaker module in this case has a first connecting side and a second connecting side. The first connecting side is connected to a busbar module, and the second connecting side is connected to a bushing module. A plurality of switch panels can be connected to one another by means of the busbar module. In the known design, a cable is connected to the switch panel by means of the bushing module.

The known circuit-breaker module has single-phase-compressed-gas-insulated phase conductor sections, while in contrast the busbar module has polyphase-compressed-gas-insulated phase conductor sections.

The known combination of single-phase and polyphase-compressed-gas-insulated phase conductor sections results in a compact switch panel, which positions a multiplicity of different modules in a physically short area. A compact structure such as this for a polyphase switch panel has the disadvantage, however, that modifications to the switch panel are possible only to a limited extent, and special designs may need to be manufactured.

The object of the invention is therefore to specify a compressed-gas-insulated polyphase switch panel which makes use of the advantages of a combination of single-phase and polyphase-compressed-gas-insulated phase conductor sections, and in this case can be modified more easily.

According to the invention, in the case of a compressed-gas-insulated polyphase switch panel of the type mentioned initially, this object is achieved in that the bushing module has polyphase-compressed-gas-insulated phase conductor sections and connection modules are arranged between the first connecting side and the busbar module as well as between the second connecting side and the bushing module, which connection modules each have single-phase-compressed-gas-insulated phase conductor sections, which present an, in particular, disconnectable connection between the single-pole-compressed-gas-insulated phase conductor sections of the circuit-breaker module and the multipole-compressed-gas-insulated phase conductor sections of the busbar module and of the bushing module.

By way of example, compressed-gas-insulated polyphase switch panels are used in switchgear assemblies which have a plurality of switch panels, that is to say at least two, which can be coupled to one another, for example, via a busbar. A polyphase switch panel is used in polyphase electrical power transmission systems, and in each case has a plurality of phase conductors which are electrically insulated from one another. The respective phase conductors are each used to carry an electric current.

In order to provide the single-phase and polyphase-compressed-gas-insulated phase conductor sections, the polyphase switch panel is equipped with appropriate encapsulating housings, which surround the phase conductor sections and hold the insulating gas which is required to provide compressed-gas insulation. Encapsulation of the insulating gas in encapsulating housings on the one hand makes it possible to prevent contamination of the insulating gas; on the other hand, it is possible to prevent the insulating gas from escaping inadvertently. In addition, the insulating gas can be subjected to an increased pressure, thus increasing the dielectric strength of the insulating gas. By way of example, gases such as sulfur hexafluoride or nitrogen etc. are suitable for use as insulating gas.

The circuit-breaker module has a plurality of phase conductor sections which are each single-pole-compressed-gas-insulated, that is to say each of the phase conductors is arranged within a separate gas area, which holds an insulating gas in its interior, such that each of the phase conductors, which must be electrically insulated on the one hand from one another and on the other hand from ground potential, is electrically insulated from an insulating gas volume which is particularly associated with this one phase conductor. Correspondingly, each of the single-phase-compressed-gas-insulated phase conductor sections is arranged in a separate gas area in the circuit-breaker module. In this case, the phase conductor sections, as part of the circuit-breaker module, may have an interrupter unit, by means of which a current path can be switched. In this case, the interrupter unit is designed such that rated currents or else short-circuit currents can be interrupted reliably.

The circuit-breaker module can be connected into a circuit via the first and the second connecting sides, with the electrical switch panel being part of this circuit.

Polyphase insulation on the phase conductor sections of the busbar module and on the phase conductor sections of the bushing module has the advantage that a relatively compact arrangement can be chosen. A plurality of phase conductor sections, which are associated with a polyphase electrical power transmission system, of the busbar module and of the bushing module are arranged in one and the same gas area, and one and the same insulating gas volume flows around them. Since the phase conductor sections of the busbar module and of the bushing module have no active components, that is to say they have no switching gaps/moving parts in the phase conductor sections, the busbar module and the bushing module are also referred to as passive modules of the switch panel. Since the passive modules are used only to carry and route current in the associated phase conductor sections, they can be optimized with respect to one another and with respect to ground potential, in terms of the insulation on the phase conductors. A bushing module and a busbar module can be made correspondingly compact. In contrast, the circuit-breaker module is equipped with an interrupter unit which is used for repeated switching of the phase conductors which are arranged in the circuit-breaker module. Modules which have movable phase conductor sections are referred to as active modules.

The switch panel is variably configurable by use of connection modules, that is to say by dispensing with direct flange connection of the bushing module and of the busbar module on one of the connecting sides of the circuit-breaker module. The connection modules can therefore be equipped in different ways, depending on their tasks and functions. The connection modules are therefore used to form an electrically conductive connection between the phase conductor sections of the polyphase-compressed-gas-insulated busbar and bushing modules, as well as the phase conductor sections of the single-phase-compressed-gas-insulated circuit-breaker module. By way of example, a structured arrangement of multipole-compressed-gas-insulated phase conductor sections in each case on the input side and output side (with respect to the power flow direction) on the switch panel also makes it possible to standardize the number of sealing surfaces which are required between the encapsulating housings of the individual modules. Furthermore, the connection modules provide a capability to arrange difference types of connection modules between the polyphase-insulated busbar and bushing module and the circuit breaker module, and also to interchange them.

A further advantageous refinement makes it possible to provide that at least one isolating switch for disconnection of the respective connection between the single-pole-compressed-gas-insulated phase conductor sections of the circuit-breaker module and the multipole-compressed-gas-insulated phase conductor sections of the busbar module and of the bushing module is arranged in each of the connection modules on the first and the second connecting sides.

An arrangement of isolating switches in the connection modules makes it possible to arrange disconnection points, which act independently of one another, both on the first connecting side and on the second connecting side after switching of the circuit breaker, which disconnection points, by way of example, provide an electrically isolating disconnection gap between the three-pole-insulated busbar module and the three-pole-insulated bushing module, even if the interrupter unit of a circuit-breaker module is connected when not desired. It is thus possible to provide an additional disconnection gap both on the first connecting side and on the second connecting side and, for example, to also electrically disconnect phase conductor sections, independently of one another, of the busbar module or of the bushing module from phase conductor sections of the circuit-breaker module.

By way of example, the isolating switches may be in the form of so-called right-angle disconnectors, that is to say the disconnection gap of the disconnector is in the form of a branch on the isolating switch. The electrically conductive connection provided by the isolating switch between the phase conductor sections for example of the circuit-breaker module and of the busbar module or of the circuit-breaker module and the bushing module is deflected, for example, through 90°.

This deflection allows a space-saving arrangement of the busbar module and of the bushing module. This reduces the physical area required to provide the polyphase switch panel. It is also advantageously possible to provide an isolating switch in combination with a grounding switch, such that phase conductor sections of the connection module, of the busbar module and of the circuit-breaker module, as well as phase conductor sections of the circuit-breaker module, of the connection module and of the bushing module, can have ground potential applied to them.

A further advantageous refinement allows a current transformer to be arranged on a connection module on at least one connecting side.

An arrangement of a current transformer on a connection module makes it possible to detect a current flow in one or more of the phase conductors of the connection module. If necessary, a current transformer may in each case be arranged on only one of the connecting sides, or on each of the connecting sides of the circuit-breaker module. The use of different connection modules makes it possible to use current transformers as required, thus allowing the switch panel to be equipped as required at that time. For example, it is also possible to provide a current transformer on a connection module, and also to arrange an isolating switch and a grounding switch on the connection module. In this case, the connection module may have an integral encapsulating housing for each phase conductor section, which housing provides a single area for accommodation of the insulating gas for each phase. However, it is also possible to provide for the connection module to have a plurality of encapsulating housings for each phase, and for a separate gas area for holding an insulating gas to be located in each of the encapsulating housings.

It is advantageously also possible for the bushing module to have a cable bushing.

Single-phase or polyphase compressed-gas insulation for the various phase conductors is provided within the switch panel, that is to say the phase conductors are arranged in the interior of a gas-tight casing which has various encapsulating housings. The casing is filled with a pressurized insulating gas. The use of a bushing module on the compressed-gas-insulated polyphase switch panel makes it possible to provide a change to alternative insulation for the phase conductors. By way of example, it is known for solid insulation to be used on cables, in order in a cost-effective manner to route phase conductors such that they are electrically insulated over relatively long distances. A cable bushing can be used on the bushing module such that a plurality of phase conductors of a plurality of cables are inserted into one and the same gas area in a bushing module, with the phase conductors having appropriate multipole compressed-gas insulation in the interior of the bushing module. The phase conductors of the cables pass through the gas-tight encapsulating housing of the bushing module in a fluid-tight and electrically insulated manner, with the insulating gas which is located in the interior of the bushing module flowing around there, and providing electrical insulation. In this case, the shape of the encapsulating housing may vary. For example, it is possible to use an essentially cylindrical encapsulating housing with a circular cross section, in which case the cables are inserted in the direction of the cylinder axis. However, it is also possible to use a cylindrical shape for the encapsulating housing of the bushing module, for example with a triangular cross section. A design such as this is particularly advantageous when providing a three-phase switch panel, with the individual cables being introduced at the respective corner points of the triangular cross section of the bushing module, which results in a high filling level in the interior of the bushing module, thus requiring a reduced volume of electrically insulating gas.

A further advantageous refinement allows the bushing module to have an open-air bushing.

In addition to use of cables for linking the compressed-gas-insulated switch panel into an electrical power transmission system, it is advantageous to use open-air bushings in order to allow the switch panel to be connected, for example, to an overhead power line. In this case, open-air bushings are used to pass the polyphase-compressed-gas-insulated phase conductors which are located in the interior of the bushing module through the encapsulating housing of the bushing module in an electrically insulated manner, while not adversely affecting the fluid-tightness of the encapsulating housing in doing so. In addition to passing the phase conductors through the encapsulating housing in a fluid-tight manner, it is necessary for the phase conductors also to be passed through the encapsulating housing in electrically stable conditions, that is to say any tendency to electrical flashovers or partial discharges on the bushings should be avoided, both on open-air bushings and on the cable bushings.

A further advantageous refinement allows a voltage transformer to be arranged on the bushing module.

Voltage transformers are used to detect electrical potentials on phase conductor sections which are located within the compressed-gas-insulated switch panel. If the voltage transformer is now arranged on the bushing module, it is possible to detect a voltage load on the switch panel, in particular at an interface to cables/overhead power lines, etc. Furthermore, the change from compressed-gas insulation to solid insulation or gas insulation with atmospheric air on the bushing module allows appropriate large-volume assemblies to be used, which are therefore appropriately mechanically robust. This results in spare space on the bushing module, which can be used to hold a voltage transformer. Following the polyphase version of the bushing module, the voltage transformer may be designed to have polyphase insulation, in particular three-phase insulation.

A further advantageous refinement allows insulating gas in adjacent modules to be mutually separated by partition walls.

The individual modules, that is to say the circuit-breaker module, the bushing module, the busbar module and the connection modules, hold single-phase or polyphase-insulated phase conductor sections in their interiors. Insulating gas flows around the phase conductor sections, in order to electrically insulate them. Corresponding barriers in the form of encapsulating housings prevent the insulating gas from escaping, thus also allowing the insulating gas to be compressed around the phase conductor sections. Mutually adjacent modules are separated from one another by partition walls. In the event of a fault within the gas insulation in one of the modules, it is therefore possible to limit this fault to this module. A partition wall prevents the fault from being passed on, for example by moisture or other contamination being dragged into other modules. Furthermore, if individual gas areas are monitored, a fault can be traced with virtually point precision. Modular replacement capabilities are provided for repair tasks, and appropriate gas tasks are required on only one or a small number of modules.

By way of example, adjacent modules can be connected to one another at a rigid angle via flange connections between fluid-tight encapsulating housings. If appropriate partition walls are placed in between in the area of the flange connection, the insulating gas in the adjacent modules can be mutually separated in a simple manner. For example, disk-type insulators can be used as partition walls, through which phase conductor sections are passed in a fluid-tight manner.

A further advantageous refinement allows a first and a second busbar module to be arranged on the first connecting side, and to be connected by means of isolating switches which are partitioned from one another.

The use of two busbar modules on one connecting side of the circuit-breaker module makes it possible to provide for the phase conductor sections of the circuit-breaker module to be connected alternately to the phase conductor sections of the first or of the second busbar module, on the first connecting side. If required, the phase conductor sections of the circuit-breaker module can also be connected in parallel to the phase conductor sections of the two busbar modules. However, it is also possible for the two busbar modules to be used as spares for one another, and for only the phase conductor sections of one of the busbar modules to be electrically conductively connected to the phase conductor sections on the first connecting side of the circuit-breaker module during normal operating conditions. Partitioning between the isolating switches ensures that faults, such as arcs occurring on one of the isolating switches, cannot act directly on the other isolating switch.

A further advantageous refinement allows phase conductor sections to pass through a compressed-gas-resistant encapsulating housing of the bushing module, in each case surrounded by a separate flange.

Separate flanges for each phase conductor section on the encapsulating housing of the bushing module allow a single-phase-insulated connection module to be connected directly to the encapsulating housing of the bushing module. This results in a compact design, which does not require use of junction housings. Particularly if the encapsulating housing of the bushing module has an essentially triangular cross-sectional structure, the separate flanges can be arranged in one and the same envelope side of a cylinder with an essentially triangular cross section. This provides a simple capability to pass the single-phase-compressed-gas-insulated phase conductors of the connection modules to the bushing module, approximately aligned with respect to one another.

However, alternatively, it is also possible for a junction housing to be arranged on the bushing module, which allows a junction to be made to single-pole compressed-gas insulation on the individual phase conductors from a flange which allows the phase conductor sections of the polyphase-compressed-gas-insulated bushing module to pass through the encapsulating housing of the bushing module, through one and the same flange. The use of a junction housing admittedly enlarges the physical volume of the bushing module. However, this allows the bushing module to be used as required, by way of example on compressed-gas-insulated polyphase switch panels which have three-phase insulation throughout.

One exemplary embodiment of the invention will be described in more detail in the following text, and is illustrated schematically in a drawing below, in which:

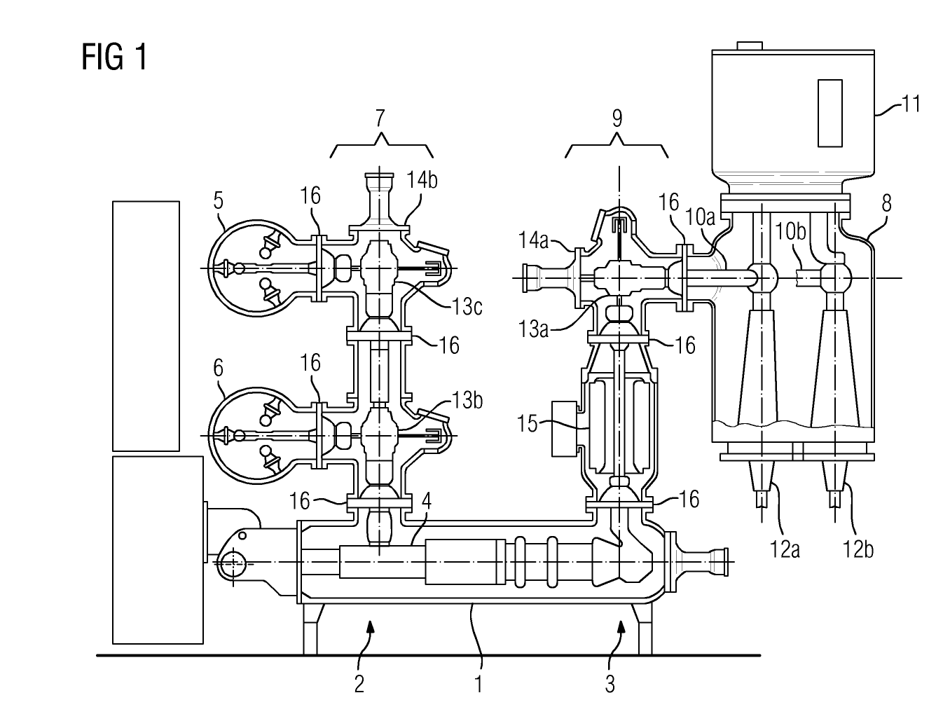

FIG. 1 shows a side elevation of a compressed-gas-insulated polyphase switch panel,

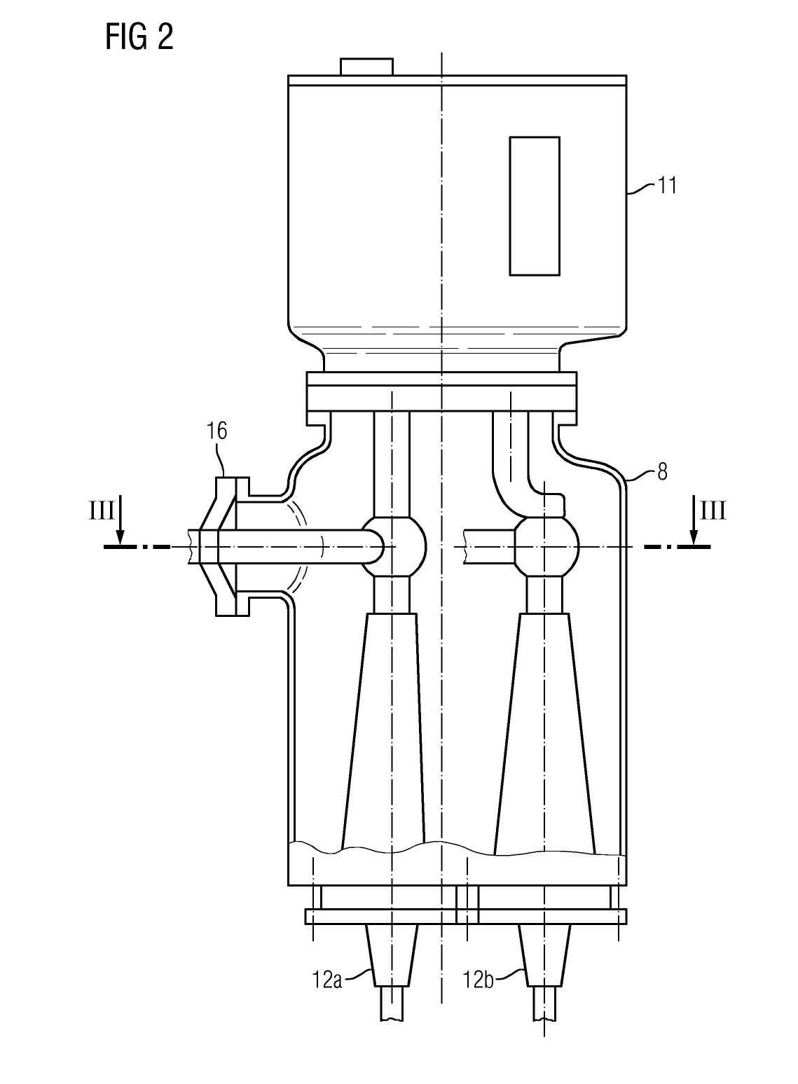

FIG. 2 shows a section through a bushing module with a voltage transformer,

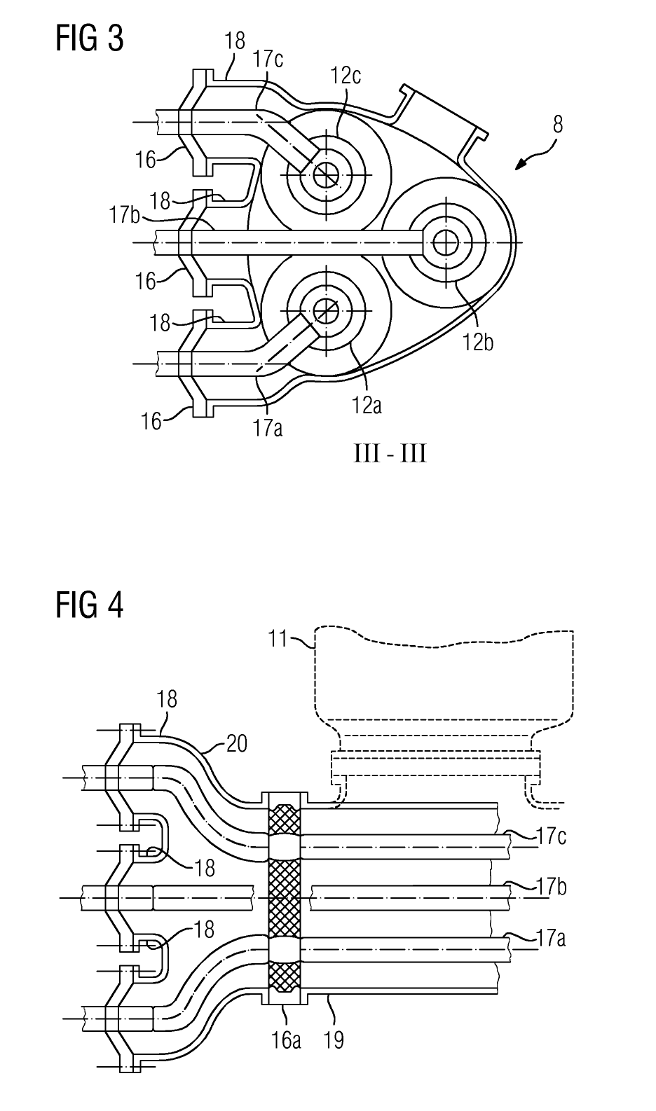

FIG. 3 shows a further section through the bushing module shown in FIG. 2, and

FIG. 4 shows a section through a junction housing.

By way of example, FIG. 1 shows a section view through a compressed-gas-insulated polyphase switch panel. The compressed-gas-insulated polyphase switch panel has a circuit-breaker module 1. The circuit-breaker module 1 has a first connecting side 2 and a second connecting side 3. The circuit-breaker module 1 is a three-phase version, that is to say the circuit-breaker module 1 has a plurality of phase conductor sections, which are used to transmit electrical power by means of a polyphase electrical power system. In the present case, the circuit-breaker module 1 and the further modules of the switch panel, and therefore the entire polyphase switch panel, are designed for three phases. The individual phase conductor sections of the circuit-breaker module 1 are aligned one behind the other, at right angles to the plane of the drawing, in the view shown in FIG. 1, as a result of which only one phase conductor section 4 of the circuit-breaker module 1 can be seen in FIG. 1. In the present case, the phase conductor section 4 of the circuit-breaker module is in the form of an interrupter unit. An interrupter unit in the phase conductor section 4 of the circuit-breaker module 1 can be used to break and make a current path between the first connecting side 2 and the second connecting side 3.

A first busbar module 5 and a second busbar module 6 are arranged on the first connecting side 2 of the circuit-breaker module 1. The two busbar modules 5 and 6 each have a plurality of phase conductor sections, which are surrounded by common polyphase compressed-gas insulation. The phase conductor sections are supported by solid insulators on encapsulating housings of the respective busbar modules 5, 6, and their longitudinal axes extend essentially in the direction at right angles to the plane of the drawing in FIG. 1. A plurality of polyphase switch panels, which are arranged parallel, can be coupled to one another via the busbar modules 5, 6. The two busbar modules 5, 6 are connected via a first connection module 7 to the first connecting side 2 of the circuit-breaker module 1.

A bushing module 8 is arranged on the second connecting side 3. The bushing module 8 is connected by means of a second connection module 9 to the second connecting side 3 of the circuit-breaker module 1. The bushing module 8 is a polyphase-compressed-gas-insulated module, such that phase conductor sections 10a, 10b which are located in the interior of the bushing module 8 are surrounded by one and the same insulating gas volume. A voltage transformer 11 is arranged on the bushing module 8. A plurality of cable bushings 12a, 12b are provided on the bushing module 8. In this case, the number of cable bushings corresponds to the number of phase conductors associated with the electrical power transmission system. In the present case, the third phase conductor section 12c of the bushing module 8 is hidden in FIG. 1.

The busbar modules 5, 6, which are each in the form of polyphase-insulated modules, and the bushing module 8 are used for coupling or connection of the compressed-gas-insulated switch panel to further switch panels or to further assemblies of an electrical power transmission system. Interfaces of the polyphase compressed-gas-insulated switch panel are therefore all in the form of polyphase compressed-gas-insulated modules. The connection modules 7, 9, which are arranged between the bushing module 8 and those busbar modules 5, 6 that are arranged at the end, as well as the circuit-breaker module 1 each have single-phase insulation, that is to say each of the phase conductor sections there is electrically insulated by separate compressed-gas insulation. The individual compressed-gas insulation elements provided for the individual phase conductor sections of the circuit-breaker module 1 and of the first connection module 7 as well as the second connection module 9 do not correspond at all to the further compressed-gas insulation elements for the respective other phase conductors. In a corresponding manner, each gas area for each of the phase conductors on the circuit-breaker module 1 and on the connection modules 7, 8 is partitioned separately.

Those busbar modules 6, 7 which are arranged at the end on the switch panel, as well as the bushing module 8, each have no moving parts in the respective phase conductor sections. The busbar modules 5, 6 and the bushing module 8 are accordingly referred to as passive modules. In contrast to this, for example, movable contact pieces are arranged in the phase conductor section 4 in the circuit-breaker module 1 and can produce a disconnection point or switching point. An arrangement of isolating switches 13a, 13b, 13c is provided in the first connection module 7 and in the second connection module 9. In the present case, the isolating switches 13a, 13b, 13c each have single-pole insulation, as a result of which all of the connection modules 7, 9 have single-phase-compressed-gas-insulated phase conductor sections. The phase conductor sections in the connection modules 7, 9 are aligned one behind the other, as a result of which only phase conductor sections of one phase of the electrical power transmission system can be seen in FIG. 1. The isolating switches 13a, 13b, 13c are in the form of right-angle disconnectors, as a result of which the isolating switches deflect the phase conductor sections through 90°. Furthermore, grounding switches 14a, 14b are additionally provided both on the first connection module 7 and on the second connection module 9, by means of which the phase conductor sections which are located in the connection modules 7, 9 can have ground potential applied to them. In this case, the ground point for the grounding switch 14a in the second connection module 9 is chosen such that the phase conductor sections which are located in the bushing module 8 can be grounded irrespective of the switch position of the isolating switch 13 in the second connection module 9.

The grounding switch 14b is positioned in the first connection module 7 such that the phase conductors which are located in the busbar modules 5, 6 can be grounded selectively or in parallel, depending on the switch position of the isolating switches 13b, 13c.

Since the phase conductor sections of both connection modules 7, 9 each have movable sections, the connection modules 7, 9, as well as the circuit-breaker module 1, are referred to as active modules.

In addition, a current transformer 15 is provided on the second connection module 9 and detects a current flow in the phase conductor sections of the second connection module 9 on the second connecting side 3 of the circuit-breaker module 1. The current transformer 15 which is shown by way of example in FIG. 1 is a so-called internal current transformer, that is to say the secondary windings of the current transformer 15 are located in the compressed-gas insulation of the phase conductor sections of the second connection module 9.

In the present case, both the first connection module 7 and the second connection module 9 are subdivided into a plurality of subsections, such that the phase conductor sections extend through compressed-gas insulation elements which are partitioned from one another in the course of the first and second connection modules 7, 9. For this purpose, the connection modules 7, 9 each have different encapsulating housings, with partition walls 16 being provided in the area where the individual encapsulating housings abut against one another. The partition walls 16 are in the form of disk-type insulators, which allow the phase conductor sections to be passed through in an electrically insulated manner, and in the process ensure mechanical robustness and retention of the phase conductor sections. In addition to use of partition walls 16 in the connection modules 7, 9, partition walls 16 of the same type and with the same function are likewise arranged at the interfaces between the individual modules. The two busbar modules 5, 6 are therefore partitioned from the adjacent first connection module 7 by appropriate partition walls 16. The bushing module 8 for each phase is likewise partitioned from the second connection module 9 by a partition wall 16, and the circuit-breaker module 1 is separated by partition walls 16 from the gas areas in the first and the second connection modules 7, 9. The modules which have moving parts of phase conductor sections (for example isolating switches, interrupter unit) are referred to as active modules.

FIG. 2 shows an enlarged form of the view of the bushing module 8 known from FIG. 1. This once again shows the cable bushings 12a, 12b which are fitted to the encapsulating housing of the bushing module 8. A section plane III-III is also marked on FIG. 2. The section through the bushing module 8 is shown in FIG. 3.

FIG. 3 shows a plan view of the two cable entries 12a, 12b, as can be seen in FIGS. 1 and 2. FIG. 3 also shows a third cable entry 12c, which is arranged in a hidden position in FIGS. 1 and 2. The cable bushings 12a, 12b, 12c are aligned essentially parallel to one another, with the bushing module 8 having an essentially triangular cross section in the area of the cable bushings 12a, 12b, 12c. Phase conductor sections 17a, 17b, 17c are each passed to the exterior through separate flanges 18 on the encapsulating housing of the bushing module 8. Partition walls 16 are located in a corresponding manner on the flanges 18 and allow sealing and positioning of the phase conductor sections 17a, 17b, 17c of the bushing module 8 through the wall of the encapsulating housing of the bushing module 8. The phase conductor sections 17a, 17b, 17c are electrically insulated by a common insulating gas volume within the bushing module 8.

FIG. 4 shows an alternative variant of a connection of a bushing module 8. The bushing module 8 is not illustrated completely in FIG. 4. In contrast to FIGS. 1 to 3, the bushing module 8 has a common flange 19, through which all the phase conductor sections 17a, 17b, 17c are passed. The flange 19 is correspondingly closed off by a partition wall 16a, through which the phase conductors 17a, 17b, 17c are passed, electrically insulated from one another. The partition wall 16 is connected to a junction housing 20. The junction housing 20 is used for a junction to a plurality of flanges 18, with each of the flanges 18 being associated with one phase conductor section 17a, 17b, 17c. This provides the capability to use encapsulating housings for a bushing module 8, on which an exit is provided for the phase conductor sections 17a, 17b, 17c through a common flange 19.

The alternative design, which is illustrated by interrupted solid lines in FIG. 4, also sketches the capability to arrange a voltage transformer 11 (in this case in a three-phase-insulated encapsulated form) on a flange 19, which voltage transformer 11 detects the electrical voltages on the phase conductors 17a, 17b, 17c. The flange 19 is used to pass the phase conductors 17a, 17b, 17c out jointly.

1-9. (canceled)

10. A compressed-gas-insulated polyphase switch panel, comprising:
a circuit-breaker module having a first connecting side, a second connecting side and single-phase-compressed-gas-insulated phase conductor sections;
a busbar module connected to said first connecting side and having polyphase-compressed-gas-insulated phase conductor sections;
a bushing module connected to said second connecting side and having polyphase-compressed-gas-insulated phase conductor sections; and
connection modules each disposed respectively between said first connecting side and said busbar module as well as between said second connecting side and said bushing module;
said connection modules each having single-phase-compressed-gas-insulated phase conductor sections providing a connection between said single-phase-compressed-gas-insulated phase conductor sections of said circuit-breaker module and said polyphase-compressed-gas-insulated phase conductor sections of a respective one of said busbar module and of said bushing module.

11. The compressed-gas-insulated switch panel according to claim 10, wherein said connections between said single-phase-compressed-gas-insulated phase conductor sections of said circuit-breaker module and said polyphase-compressed-gas-insulated phase conductor sections of a respective one of said busbar module and of said bushing module are configured to be disconnected.

12. The compressed-gas-insulated switch panel according to claim 10, which further comprises at least one disconnecting switch disposed in each of said connection modules on said first and second connecting sides and configured to disconnect said respective connection between said single-phase-compressed-gas-insulated phase conductor sections of said circuit-breaker module and said polyphase-compressed-gas-insulated phase conductor sections of a respective one of said busbar module and of said bushing module.

13. The compressed-gas-insulated switch panel according to claim 10, which further comprises a current transformer disposed on one of said connection modules on at least one connecting side.

14. The compressed-gas-insulated switch panel according to claim 10, wherein said bushing module has a cable bushing.

15. The compressed-gas-insulated switch panel according to claim 10, wherein said bushing module has an outdoor bushing.

16. The compressed-gas-insulated switch panel according to claim 10, which further comprises a voltage transformer disposed on said bushing module.

17. The compressed-gas-insulated switch panel according to claim 10, which further comprises partition walls mutually separating insulating gas in adjacent modules.

18. The compressed-gas-insulated switch panel according to claim 10, which further comprises disconnecting switches being partitioned from one another, said busbar module being one of first and second busbar modules disposed on said first connecting side, and said disconnecting switches being configured to connect said first and second busbar modules.

19. The compressed-gas-insulated switch panel according to claim 10, which further comprises a compressed-gas-resistant encapsulating housing of said bushing module and separate flanges, each of said phase conductor sections passing through said housing surrounded by a respective one of said separate flanges.
